(19) United States
(12) Patent Application Publication
(10) Pub. No.: US 2004/0186893 A1
(43) Pub. Date: Sep. 23, 2004

(54) Abnormality detection method, abnormality detection program, server, computer

(75) Inventor: Mikako Ochiai, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/766,860

(22) Filed: Jan. 30, 2004

(30) Foreign Application Priority Data
Feb. 26, 2003 (JP) 2003-49255

(51) Int. Cl. G06F 15/173

(52) U.S. Cl. 709/206; 709/224; 714/38

(57) ABSTRACT

An abnormality detection method on a server, by which the server for providing an electronic mail transmission service via a network to a computer making a request for transmitting an electronic mail detects an operational abnormality of the computer, the method comprises a step of accepting the electronic mail transmission request from the computer; a step of transmitting the electronic mail of which the transmission request has been accepted; a step of accumulating transmission history information about the transmitted electronic mail; a step of referring to request history information about a transmission request history of the electronic mail that is accumulated on the computer; a step of comparing the transmission history information with the request history information; and a step of detecting the operational abnormality of the computer on the basis of a result of the comparison.

### BACKGROUND OF THE INVENTION

The invention relates to a technology of detecting an abnormal electronic mail transmission. In particular, it relates to a technology of detecting a computer virus on the occasion of transmitting and receiving the electronic mail via a mail server.

A majority of infection sources of computer viruses are said to be electronic mails. A general countermeasure against the viruses involves utilizing an anti-virus server for a gateway in order to safeguard a whole network such as a LAN. Further, a countermeasure against the virus on a terminal basis involves installing a piece of anti-virus software.

The anti-virus server and the anti-virus software previously have information (for example, a pattern file) on the known computer viruses.

In the anti-virus server and the anti-virus software, the computer virus has hitherto been detected by comparing the pattern file with the transmitted mail and data attached to the mail.

[Patent Document 1]

Japanese Patent Application Laid-Open Publication No. 2002-196942

By the way, in the computer viruses, there exists a virus that transmits the same type of virus as the computer virus itself as a mail a mail address registered in a mail address book of mail software installed into a user terminal.

There is a possibility in which not only a computer of a mail recipient but also computers of other user existing in the mail address book might be infected by this type of computer virus. In this case, the mail recipient becomes a mail sender and might be therefore turn out to be an assailant.

The conventional anti-virus server and the anti-virus software must frequently update the pattern file.

Hence, if the pattern file is not updated latest at all times, only the computer viruses that the pattern file supports can be detected.

Moreover, the conventional anti-virus server and the anti-virus software are incapable of detecting unknown computer viruses. Therefore, damages by the computer viruses spread, and, after that has been proven, the countermeasures were often taken.

### SUMMARY OF THE INVENTION

Such being the case, the invention, which was made in view of the items given above, aims at providing an abnormality detection method, a storage medium that stored an abnormality detection program, a server and a computer which detect an operational abnormality of a computer that is derived from the viruses and other causes.

Moreover, the invention aims at providing an abnormality detection method, a storage medium that stored an abnormality detection program, a server and a computer which detect a clue of an unknown computer virus.

The invention adopts the following means (unit) for solving the problems. Namely, the invention is an abnormality detection method of detecting an operational abnormality of a computer, executed by an electronic mail system comprising the computer for making a request for transmitting an electronic mail and a server for transmitting the electronic mail in response to the request from the computer, the method comprising a step of referring to request history information related to a transmission request history of the electronic mail by the computer, a step of referring to transmission history information of the electronic mail by the server, a step of comparing the request history information with the transmission history information, and a step of detecting the operational abnormality of the computer on the basis of a result of the comparison.

The computer includes a personal computer, a mobile terminal, etc. capable of transmitting and receiving the electronic mail.

It is preferable that the server be a provider for performing a connection service to the Internet but is not limited to this. The server refers to the request history information and may therefore have the request history information transmitted from the computer. Further, the server may be so set as to be capable of referring the request history of the computer via the network.

In addition, it is preferable that a step of informing the computer that the operational abnormality of the computer has been detected be added to the abnormality detection method of the invention. As the informing method, there preferably performed a method of displaying a message on a display means, etc. of the computer, or a method of transmitting the electronic mail to a computer owner (user), and so on. An alarming sound may also be emitted by way of other method.

The user of the computer is thereby able to promptly grasp the abnormality of the computer, thereby making it possible to prevent a spread of damages.

Moreover, it is preferable that the request history information and/or the transmission history of the invention contain pieces of information such as an address of a transmitting destination of the electronic mail transmitted from the computer, a user name, etc., information about a transmission route, pieces of information such as an address of a transmitting source of the electronic mail, a user name, etc., pieces of information such as a content of an electronic mail text, a tile of the electronic mail, an attached file existed or non-existed, an attached file name, etc.

Further, the request history information of the invention may contain, e.g., a date/time (a transmitting date/time) when a transmission request is made from on the computer, and the transmission history information of the invention may contain a date/time when the sever accepted the electronic mail and a date/time when transmitting the accepted electronic mail to the transmitting destination. Thus, whether the virus exists or not is detected from a result of the comparison between the request history information and the transmission history information, and hence the virus having a mail transmission function by the virus itself, can be detected.

Moreover, in the abnormality detection method of the invention, the comparison between the pieces of history information may be made on the side of a user terminal and may also be made by other terminals different depending on the server and the user.

Still further, the abnormality detection method of the invention detects the virus not from a virus patter but from the mail transmission history and the request history information such as an operation history, etc. of mail software, and it is therefore feasible to detect the virus even on the computer where the latest virus definition information is not updated. Namely, according to the invention, an unknown virus can be detected, and an epidemic of the virus can be prevented.

Further, the abnormality detection method of the invention can be, without being limited to detecting the abnormality of the operation state due to the virus, applied to detecting an operational abnormality due to some fault of the server or the computer.

Moreover, the abnormality detection method of the invention may include a step of referring to a transmission confirming condition when transmitting the electronic mail on the computer, and a step of confirming the transmission history information containing the electronic mail of which the transmission has been requested latest in accordance with the transmission confirming condition. Then, in case a result of the confirmation in the confirming step meets a predetermined standard, the transmission history information may be compared with the request history information.

Thus, a step of comparing the transmission history information accumulated by the server itself with the transmission confirming condition is added to the step of comparing the request history information accumulated by the computer with the transmission history information accumulated by the server, whereby the possibility of an existence of the virus can be detected with a high accuracy.

Further, the invention may be a storage medium that stored a program or the program by which a server for providing an electronic mail transmission service via a network to a computer making a request for transmitting an electronic mail detects an operational abnormality of the computer. The program of the invention is characterized by making the server execute a step of referring to transmission history information related to the electronic mail transmitted based on the transmission request of the electronic mail from the computer, a step of referring to request history information related to a transmission request history of the electronic mail by the computer, a step of comparing the transmission history information with the request history information, and a step of detecting the operational abnormality of the computer on the basis of a result of the comparison.

This program can be executed by its being installed into a hard disk of the server, the computer and any one of terminals other these. For instance, the abnormality detection program of the invention is installed into the computer's side, whereby the computer is made to execute a step of referring to the request history information related to the electronic mail of which the transmission request has been given to the server, a step of referring to the transmission history information related to the transmission history of the electronic mail accumulated on the server, a step of comparing the request history information with the transmission history information, and a step of detecting an operational abnormality on the basis of a result of the comparison.

The program of the invention is installed into the had disk of the computer, whereby the process of comparing the request history information with the transmission history information can be executed on the computer's side. Therefore, whether the virus exists or not can be checked whenever the user wants to do. Furthermore, in the abnormality detection method of the invention, whether the virus exists or not may be checked not only when transmitting the electronic mail but also periodically.

Moreover, the invention may be a server for providing an electronic mail transmission service to a computer making a request for transmitting an electronic mail.

The server of the invention is characterized by comprising accepting means for accepting an electronic mail transmission request from the computer, transmitting means for transmitting the electronic mail of which the transmission request has been accepted, accumulating means for accumulating transmission history information about the transmitted electronic mail, history referring means for referring, from on the computer, to request history information about a transmission request history of the electronic mail that is accumulated on the computer, comparing means for comparing the transmission history information with the request history information, and detecting means for detecting an operational abnormality of the computer on the basis of a result of the comparison.

Moreover, the invention may be a computer requesting a server for providing an electronic mail transmission service to transmit an electronic mail. The computer of the invention is characterized by comprising requesting means for requesting the server to transmit the electronic mail, accumulating means for accumulating request history information about the electronic mail of which the transmission has been requested, server history referring means for referring, from on the server, to transmission history information about a transmission history of the electronic mail that is accumulated on the server, comparing means for comparing the request history information with the transmission history information, and detecting means for detecting an operational abnormality on the basis of a result of the comparison.

### DESCRIPTION OF THE DRAWINGS

FIG. 1 is a conceptual diagram of a mail transmission system in a first embodiment.

FIG. 2 is a conceptual diagram when a virus transmits a mail by exploiting its own mail engine.

FIG. 3 is a diagram of system architecture in the first embodiment.

FIG. 4 is a list of request history data on a mail client in the first embodiment and a second embodiment.

FIG. 5 is a list of transmission history data on a mail server in the first embodiment and the second embodiment.

FIG. 6 is a list of contents of setting by a comparison necessary condition setting in the first embodiment and the second embodiment.

FIG. 7 is a list of operation history data on the mail client in the first embodiment and the second embodiment.

FIG. 8 is a flowchart showing an abnormality detection procedure in the first embodiment.

FIG. 9 is a diagram of system architecture in the second embodiment.

FIG. 10 is a flowchart showing an abnormality detection procedure in the second embodiment.

### DETAILED DESCRIPTION OF THE INVENTION

An abnormality detection system and an abnormality detection method in the embodiment will be explained.

<First Embodiment>

(Outline of the Invention)

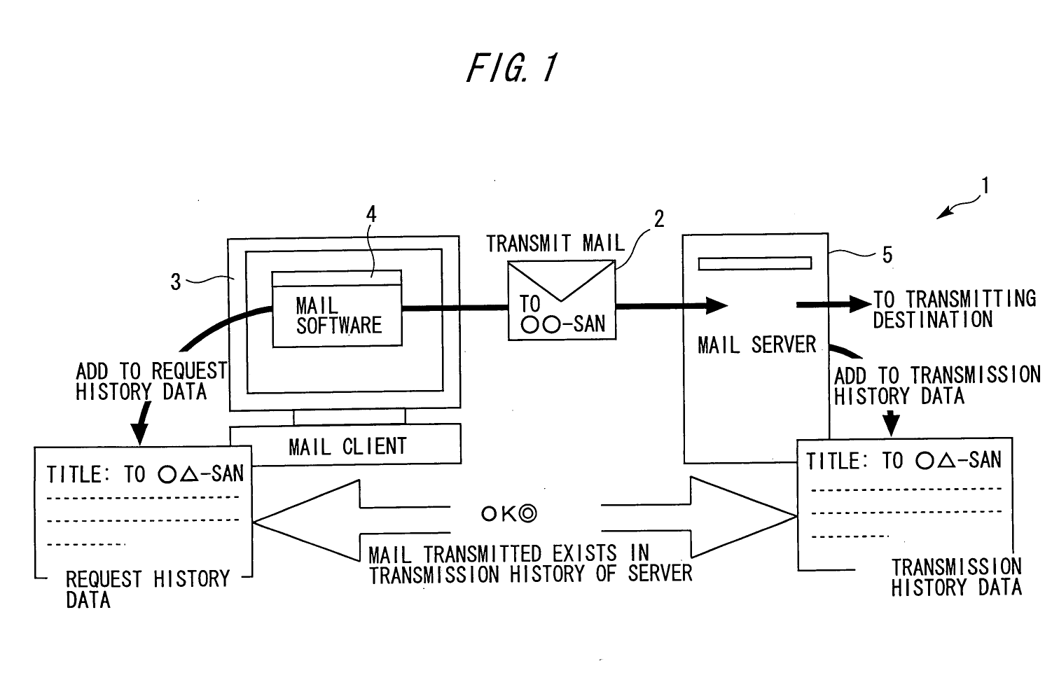

FIG. 1 shows a conceptual view of a mail transmission system in an embodiment. A transmission of an electronic mail (which will hereinafter be called a mail) 2 in the embodiment is performed by utilizing mail software 4 of a user terminal (which will hereinafter be referred to as a mail client) 3.

At this time, the mail client 3 accumulates various pieces of history data (corresponding to request history information which will hereinafter be called request history data) about the transmitted mails 2 within the mail client 3. The request history data can be exemplified such as an address of a transmitting destination, a transmission date/time, a tile of the mail transmitted, an attached file existed or non-existed, and so on.

The mail 2 transmitted from the mail client 3 is relayed across a server (that will hereinafter be termed a mail server) 5 and delivered to the transmitting destination. The mail server 5 transmits the mail 2, of which a transmission request is received by the server 5, to a terminal of the transmitting destination. The mail server 5, when transmitting this mail 2, accumulates transmission history data (corresponding to transmission history information) about the mail 2 in a database within the mail server 5.

At this time, the request history data accumulated by the mail client 3 and the transmission history data accumulated by the mail server 5, contain information about the same mail. In the embodiment, the mail is transmitted in this architecture.

Then, in the abnormality detection method in the embodiment, as described above, when transmitting the mail, it is detected whether there is a fact that a virus has transmitted this mail or not.

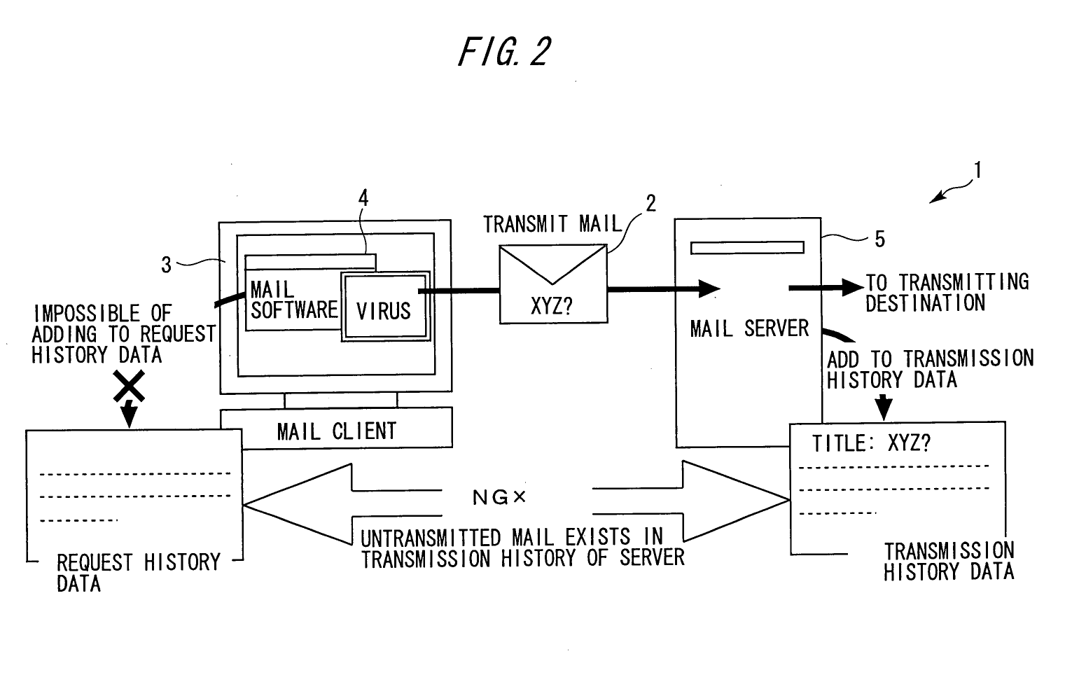

FIG. 2 shows a conceptual view in the case where the virus in the embodiment has transmitted the mail independently. It is assumed that the virus in the embodiment has a function (a mail engine) of independently transmitting the mail.

As explained above, if the mail is transmitted by the mail software 4, the request history data of this mail is accumulated on the mail client 3. On the other hand, in case the virus transmits the mail by its own mail engine, the mail is to be transmitted without utilizing the mail software 4, and hence the request history data of the transmitted mail is not accumulated on the client terminal 3.

The mail of which the transmission was requested by the virus is also, however, transmitted to the transmitting destination via the mail server 5. Therefore, the mail of which the transmission was requested by the virus is sent once via the mail server 5. Herein, the mail server 5, when transmitting to the transmitting destination the mail transmitted by the virus, accumulates the transmission history data of that mail.

Then, the mail server 5 compares the request history data recorded on the mail client 3 with the transmission history data recorded on the mail server 5. By this comparison, in case the mail server 5 has the transmission history data of the mail that does not exist in the request history data of the mail client 3, it is understood that the mail client 3 having transmitted this mail has a high possibility of being infected by the virus.

Next, system architectures of the mail client 3 and the mail server 5 in the embodiment will be explained.

(System Architecture)

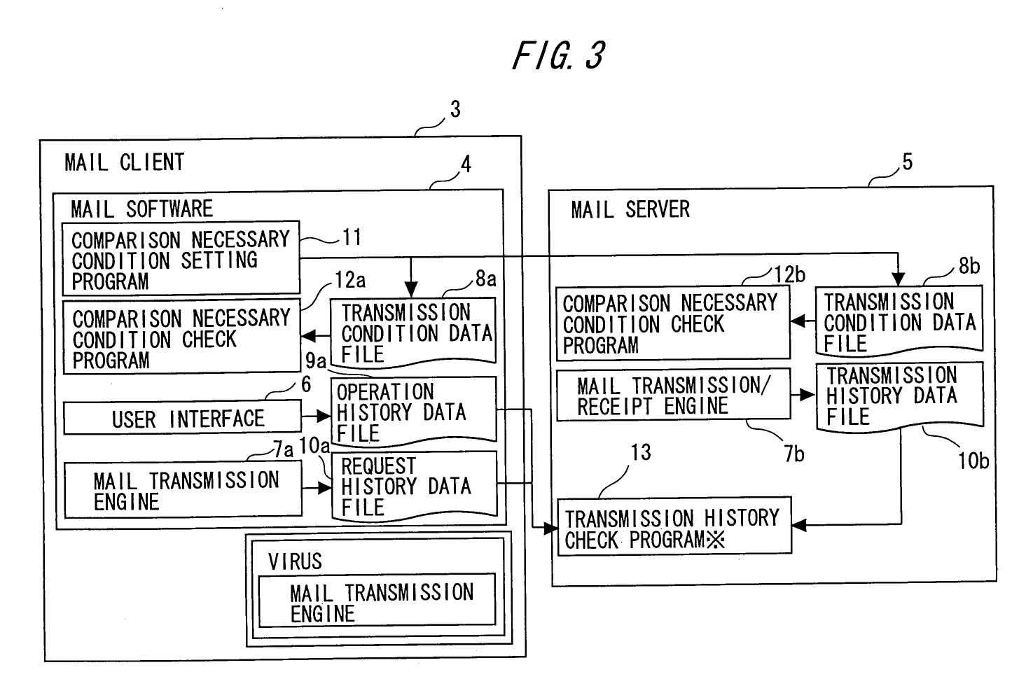

FIG. 3 illustrates the system architectures of the mail client 3 and the mail server 5 in the embodiment.

To begin with, the mail client 3 in the embodiment will be described. The mail client 3 is assumed to be an existing personal computer including a CPU (Central Processing Unit) for controlling the whole mail client 3, a ROM (Read Only Memory) stored with basic programs executed by the CPU, a HD (Hard Disk) stored with an operating system, a variety of applications and various categories of data that are executed by the CPU, a RAM (Random Access Memory) for temporarily storing the programs executed by the CPU and processing data on the CPU, a communication interface for transmitting and receiving the data via a network, and an input interface for a user to input the various categories of data from outside (none of those are shown).

The mail client 3 in the embodiment is preinstalled with the mail software 4. This piece of mail software 4 has a user interface 6 for operating the application from on the mail client 3, and a mail transmission engine 7a for transmitting the mail.

Further, the HD of the mail client 3 is stored with a plurality of request history data files. These request history data files are a transmission condition data file 8a stored with transmission condition data of the mail, an operation history data file 9 stored with an operation history of the mail software 4, and a request history data file 10a when transmitting the mail. These files are structured within the HD. Note that these pieces of history data will be explained later on.

Further, the mail software 4 had a comparison necessary condition setting program 11. The comparison necessary condition setting program 11 is a program for presetting condition parameters about the mail transmission and storing the transmission condition data file 8a with the condition parameters. Note that various categories of data set by the comparison necessary condition setting program 11 will be hereinafter be described.

Moreover, the mail software 4 has a comparison necessary condition check program 12a for comparing the set conditions with the data stored actually in the file.

Next, the mail server 5 in the embodiment will be described. The mail server 5 is also assumed to be, as the mail client 3 is, an existing personal computer including a CPU for controlling the whole mail server 5, a ROM stored with basic programs executed by the CPU, a HD stored with an operating system, a variety of applications and various categories of data that are executed by the CPU, a RAM for temporarily storing a content of the processing by the CPU, and a communication interface for transmitting and receiving the data via the network (none of those are shown).

Moreover, the mail server 5 has a mail transmission engine 7b. In addition, the HD of the mail server 5 is stored with a transmission condition data file 8b stored with transmission condition data transmitted from the mail client 3, a transmission history data file 10b stored with transmission history data when transmitting to the transmitting destination the mail of which the transmission is requested by the mail client 3, and a comparison necessary condition check program 12b.

For others, the HD of the mail server 5 in the embodiment is preinstalled with a history check program 13 for comparing the request history data stored on the mail client 3 with the transmission history data stored on the mail server 5.

Moreover, the mail server 5 and the mail client 3 in the embodiment utilize, for example, SMTP (Simple Mail Transfer Protocol) as a communication protocol for transmitting the electronic mail, and POP (Post Office Protocol) as a communication protocol for receiving the electronic mail. Note that other known protocols may, as a matter of course, also be utilized.

What has been given so far is the system architectures of the mail client 3 and of the mail server 5 in the embodiment.

(Data Structure)

Next, the request history data stored in the request history data file 10a of the mail client 3 will be explained.

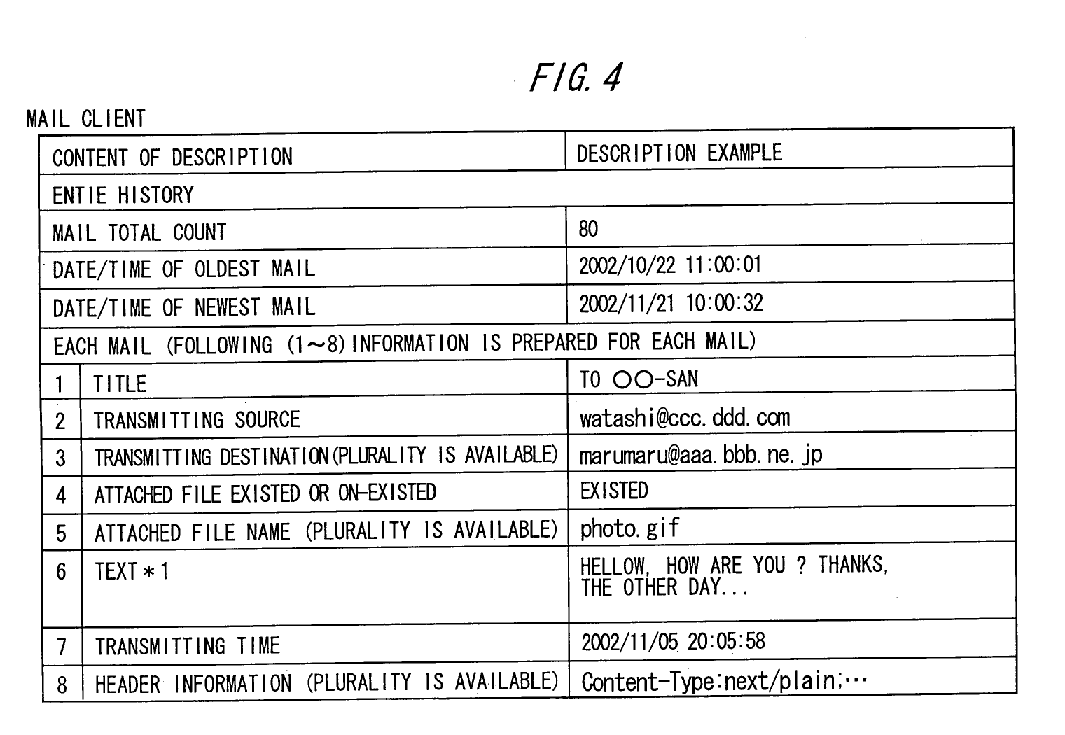

FIG. 4 shows a list of the request history data accumulated on the mail client 3. The request history data accumulated on the mail client 3 are classified into data about the history of the entire mails transmitted to the mail server 5, and data about the history of the respective mails.

The request history data of the entire mails contain a total number of mails transmitted to the mail server 5, a transmitting date/time of the oldest mail, a transmitting date/time of the latest mail, and updated virus definition information (pattern file) receiving date/time.

The request history data of each mail contain a tile of the transmitted mail, an address of a transmitting source that sent the mail, an address of the mail transmitting destination, an attached file existed or non-existed, a name of attached file, a text of the transmitted mail, a transmitting date/time and a header of the transmitted mail.

Next, the transmission history data stored in the transmission history data file 10b of the mail server 5 will be explained.

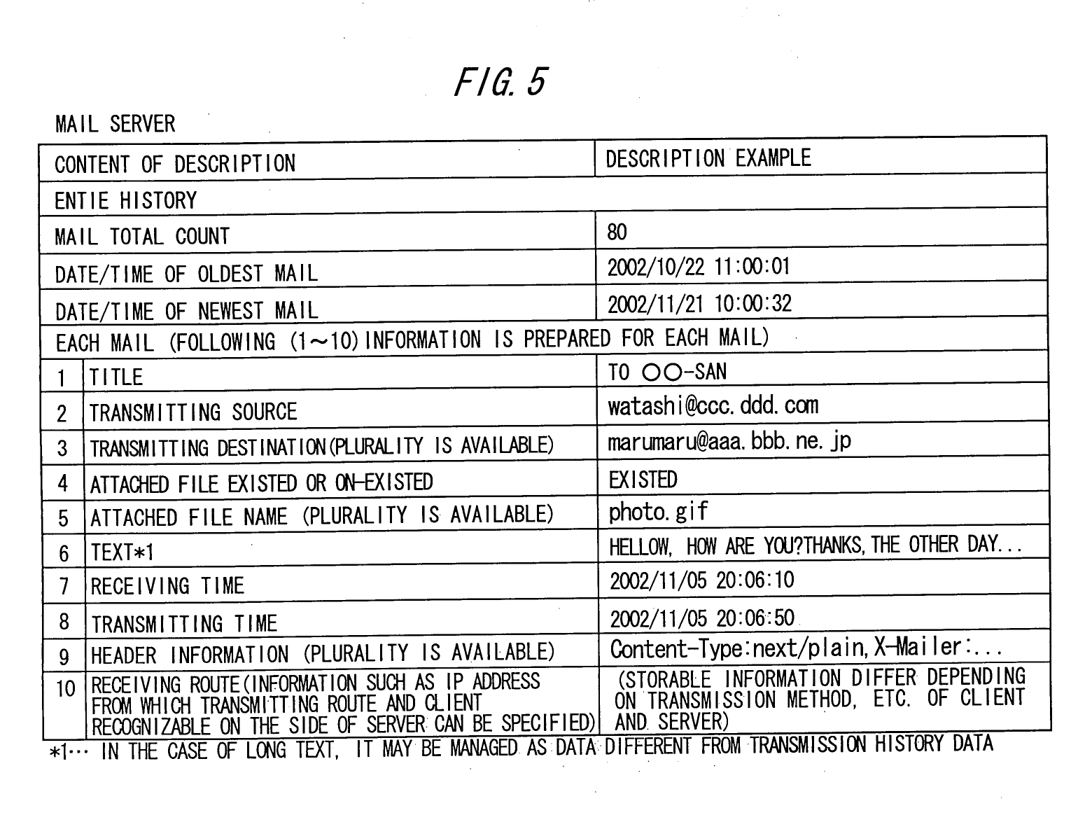

FIG. 5 shows a list of the transmission history data accumulated on the mail server 5. The transmission history data accumulated on the mail server 5 are classified into transmission history data about the entire transmitted mails of which transmissions are requested by the mail clients 3, and transmission history data about the respective mails.

The transmission history data about the entire mails contain a total number of transmitted mails of which the transmissions were requested by the mail clients 3, a transmitting date/time of the oldest mail and a transmitting date/time of the latest mail.

The transmission history data of each mail contain a tile of the transmitted mail, an address of a transmitting source of the mail, an address of a transmitting destination of the mail, an attached file existed or non-existed, a name of the attached file, a text of the mail, an acceptance data/time (a receiving time) when accepting the mail transmission request from the mail client 3, a transmitting date/time when transmitting the mail to the transmitting destination, a header of the mail, and transmission route information given from the mail client 3.

What has been given so far is the description of the request history data and the history data which are accumulated on the mail client 3 and on the mail server 5. The comparison necessary condition setting program 11 is a program for setting conditions when comparing the aforementioned request history data with the transmission history data (which will hereinafter be expressed such as “comparing the histories”).

Then, an example of how the comparison necessary condition setting program 11 sets the conditions will next be explained.

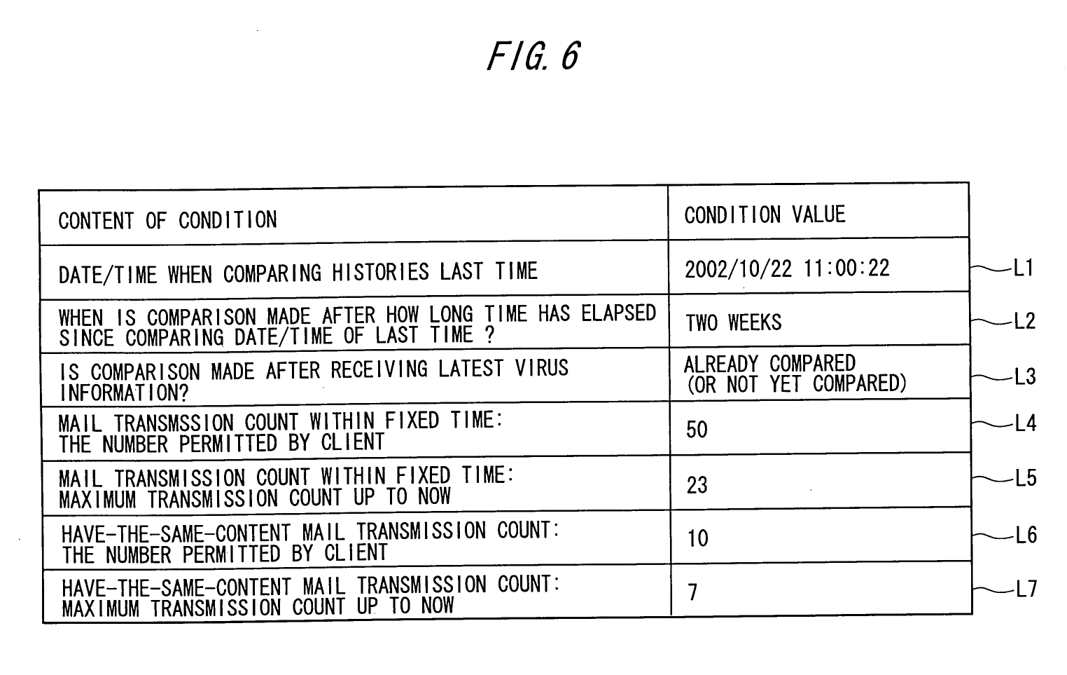

FIG. 6 shows a list of contents of the setting by the comparison necessary condition setting program 11. At first, items of this list will be described.

The item designated by L1 in FIG. 6 is an item of a “date/time when the history comparison has been made last time”. The date/time when the history comparison has been made last time is to be recorded on the occasion that the history comparing program has compared the request history data with the transmission history data last time.

The item designated by L2 in FIG. 6 is an item of “when is the comparison made after how much the time has elapsed since the comparing date/time of the last time?”. This item can be set by a user, wherein a basic time point is the date/time in the item L1. For instance, the user can set the conditions such as making the history comparison after every elapse of two weeks since the date/time when the history comparison was made last time.

The item designated by L3 in FIG. 6 is an item of “whether or not the comparison is made after receiving the updated virus information”. Namely, in case the date/time when receiving the updated virus information is anterior to the date/time in the item L1, this implies that the history comparison has been made after receiving the updated virus information.

The item designated by L4 in FIG. 6 is an item of a “mail transmission count within a fixed time: a client-permitted number”. This item is an item for setting an upper limit number of the mails transmitted for a fixed (predetermined) time by the mail client 3.

The item designated by L5 in FIG. 6 is an item of “a mail transmission cunt within a fixed time: a maximum transmission count up to now”. This item is to be recorded each time the mail is transmitted within the fixed time from the mail client 3. Then, if a transmission count exceeding the maximum transmission count up to now is counted, the maximum transmission count is updated.

The item designated by L6 in FIG. 6 is an item of a “have-the-same-content mail transmission count: the number permitted by the mail client 3”. This is an item for setting an upper limit of the transmission count of the multi-cast mails transmitted by the mail client 3.

The item designated by L7 in FIG. 6 is an item of a “have-the-same-content mail transmission count: a maximum transmission count up to now”. It is preferable that the maximum transmission count in this item be updated when a transmission count exceeding the maximum transmission count up to now is counted.

As shown in FIG. 3, the setting contents described above are accumulated as the transmission condition data in the transmission condition data file 8a of the mail client 3. Further, the transmission condition data are, though will be explained later on, transmitted to the mail server 5 from the mail client 3. Therefore, the transmission condition data are also accumulated in the transmission condition data file 8b of the mail server 5.

Given next is an explanation of the operation history data of the mail software 4, which are stored in the operation history data file 9 of the mail client 3.

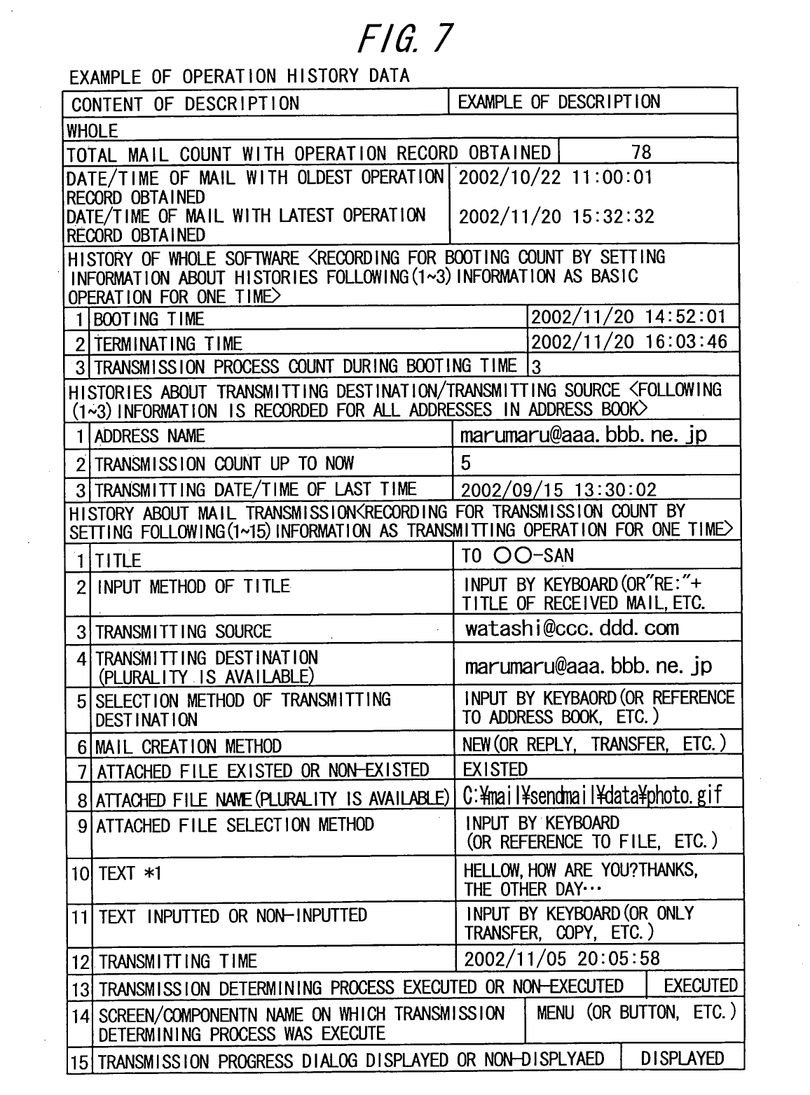

FIG. 7 shows a list of the operation history data. The operation history data contain a history concerning the entire mails transmitted by use of the mail software 4, a history about the mail transmitting destination/transmitting source, and a history about the respective mails sent to the mail server 5.

The history about the entire mails transmitted by utilizing the mail software 4 contains a total number of the mails with the operation records acquired, an operation date/time of the mail software 4 when requesting the transmission of the oldest mail, and an operation date/time of the mail software 4 when requesting the transmission of the latest mail.

The history pertaining to the booting of the mail software 4 contains a boot end date/time of the mail software 4 and the number of mails transmitted during the booting of the mail software 4.

The history about the mail transmitting destination contains a total number of mails transmitted so far to the transmitting destination, and a date/time when transmitting the mail to the transmitting destination last time. Note that the history about the mail transmitting source contains a type of the mail software used by the mail client 3, a mail address, etc.

The history about each of the mails of which the transmission request was given to the mail server 5 contains a title of the mail of which the transmission request was given thereto, a title input method, a mail address of the transmitting source, a mail address of the transmitting destination, and data of a method of selecting the transmitting destination. The title input method differs depending on a case where the user input an arbitrary title directly from a keyboard, etc. and a case where “Re+received mail title” automatically given when replying becomes a title and hence there is no necessity of specially inputting the title. Further, as the method of selecting the transmitting destination, there are a method that the user directly inputs an address of the selected destination through the input interface such as the keyboard, etc. and a method that the user selects an address of the selected destination from an address book loaded into the mail software 4 by use of a mouse, etc.

Moreover, the history about each of the mails of which the transmission request was given to the mail server 5, contains a mail creation method, an attached file existed or non-existed, a name of the attached file and an attached file selection method. The mail creation method connotes a mailing category such as a new creation, a reply, a transfer and so on. Further, as the name of the attached file, it is preferable that a plurality of names be recorded by delimiting with a comma, semicolon, etc.

For others, the history about each of the mails of which the transmission request was given to the mail server 5 from the mail client 3, contains a content of the mail text, a text inputted or non-inputted, a mail transmitting date/time, a transmission determining process executed or non-executed, a history of screen/component name where the transmission determining process was executed, and a mail post-transmitting transmission progress dialog displayed or non-displayed.

The text inputted or non-inputted implies the text inputted in a case where the user directly inputs the text from the input interface such as the keyboard, etc., and implies the text non-inputted in a case where the text is created by transferring/copying and so forth.

The transmission determining process executed or non-executed implies whether there is a process for determining the transmission of the mail or not. This transmission determining process can be exemplified by a processing method such as executing “Mail Transmission” as from an icon and a menu.

The history about the screen/component name on which the transmission determining process is executed is a history of a content as to whether the transmission determining process is executed from on the icon (button) provided on the screen or from on the menu screen.

What has been given above is the description of the operation history data accumulated in the operation history data file 9 of the mail client 3.

(Abnormality Detection Processing Procedure)

An abnormality detection procedure in the embodiment will hereinafter be explained.

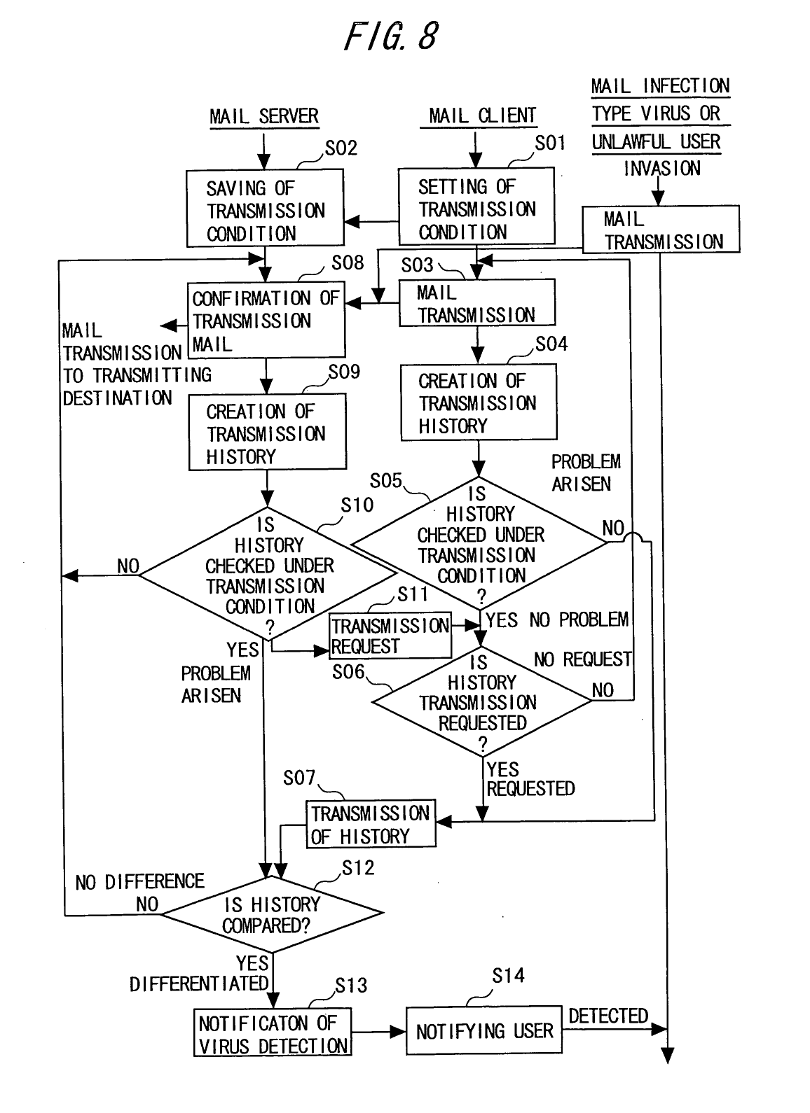

FIG. 8 shows a flowchart of the abnormality detection procedure in the embodiment.

To begin with, the CPU of the mail client 3 executes the comparison necessary condition setting program 11. Here, the user sets the transmission condition data based on the comparison necessary condition setting program 11 (S01). In this setting, the setting contents shown in FIG. 5 are set. For example, two weeks are set in the item of “when the comparison is made after how much the time has elapsed since the comparing date/time of the last time, 50 mails are set in the item of a “mail transmission count within a fixed time”, and 10 mails are set in the item of the “have-the-same-content mail transmission count”.

Then, the transmission condition data set by the user are accumulated in the transmission condition data file 8a of the mail client 3.

The comparison necessary condition setting program 11, upon receiving a completion of setting the transmission condition data, transmits to the mail server 5 the transmission condition data inputted by the user. Upon receiving a completion of the transmission of the transmission condition data, the comparison necessary condition setting program 11 terminates.

The mail server 5 having received the setting contents saves the setting contents in the transmission condition data file 8b (S02).

On the other hand, the mail client 3, upon detecting a user's operation of transmitting the mail, requests the mail server 5 to transmit this mail (S03).

With the mail transmission request, the CPU of the mail client 3 creates the request history data of the mail and accumulates them in a predetermined file (S04). The request history data created herein contain the request history data shown in FIG. 4 and the operation history data shown in FIG. 7.

Upon a completion of accumulating the request history data, the CPU of the mail client 3 executes the comparison necessary condition check program 12a. The comparison necessary condition check program 12a effects a process of comparing the transmission condition data shown in FIG. 6 that have been set by the comparison necessary condition setting program 11 with the request history data accumulated (S05).

Namely, the comparison necessary condition check program 12a executes, based on the transmission condition data and the request history data about the mails, a comparing process as to items of whether or not a predetermined number of days (for example, two weeks) have elapsed since the comparing date/time of the last time, whether or not the comparing process is executed after receiving the updated virus information, whether or not the mail transmission count within the fixed time exceeds a set value (for instance, 50 mails), and whether or not the have-the-same-content mail transmission count exceeds a set value (e.g., 10 mails).

Herein, in case the request history data shown in FIG. 4 meet the transmission condition data shown in FIG. 6, the comparison necessary condition check program 12a executes a more elaborate check. Namely, the comparison necessary condition check program 12a compares the request history data accumulated by the mail client 3 with the transmission history data accumulated by the mail server 5. Note that the comparison necessary condition check program 12a may make a judgment that all the items described above must be met, and may also make a judgment that there be no problem unless the items having a higher degree of significance are met. For instance, a case that the mail transmission count within the fixed time exceeds the set number and a case that the set number of have-the-same-content mails are transmitted, have a high possibility of the mails being transmitted by the virus and can therefore be said to be the items having the higher degree of significance.

In case the comparison necessary condition check program 12a judges in step 05 that the request history data shown in FIG. 4 do not meet the transmission condition data shown in FIG. 6, it is checked whether a request for the transmission history data is given from the mail server 5 or not (S06).

Herein, in case the comparison necessary condition check program 12a judges that no request for the request history data is given from the mail server 5, returning to step S03, the same process is repeated. While on the other hand, in case the comparison necessary condition check program 12a judges that the request for the request history data is given from the mail server 5, the request history data are transmitted to the mail server 5 (S07).

On the other hand, the comparison necessary condition check program 12a judges that the request history data meet the transmission condition data, the comparison necessary condition check program 12a transmits the accumulated request history data to the mail server 5 (S07).

Further, in step 02, the mail server 5 having received the mail transmission request from the mail client 3 receives the mail of which the transmission was requested by the mail client 3 (S08). The mail server 5, after confirming the receipt of the mail of which the transmission was requested, transmits the mail to the transmitting destination.

The CPU of the mail server 5, together with the mail transmission, accumulates the transmission history data about the transmitted mail in a predetermined file (S09). Note that the transmission history data herein connote the aforementioned transmission history data shown in FIG. 5.

The CPU of the mail server 5, corresponding to the accumulation of the transmission history data, executes the comparison necessary condition check program 12b (S10). The comparison necessary condition check program 12b compares the transmission history data accumulated by the mail server 5 with the transmission condition data transmitted from the mail client 3 in step 02. Note that the comparative items are the same the comparative items of the comparison necessary condition check program 12a on the mail client 3, and hence their explanations are omitted.

In case the comparison necessary condition check program 12b judges in step 10 that the transmission history data do not meet the transmission condition data, returning to step 08, the same process is repeated.

On the other hand, in the case of judging in step 10 that the transmission history data meet the transmission condition data, the comparison necessary condition check program 12b executes a transmission request process of the request history data for the mail client 3 (S11).

Corresponding to the receipt of the request history data transmitted from the mail client 3, the CPU of the mail server 5 executes the history check program 13 (S12).

The history check program 13 compares the request history data accumulated by the mail client 3 which are shown in FIG. 4 with the transmission history data accumulated by the mail server 5 which are shown in FIG. 5.

A premise in the following comparative example is that the mail transmitted by the mail server in response to the transmission request from the mail client, be the same as the mail of which the transmission has been requested by the mail client 3 within a predetermined time (e.g., 10 min.) before and after a date/time (receipt date/time) when the mail server 5 received the transmission request. It is to be noted that a transmitting date/time may also be used in place of the receiving date/time.

Further, whether or not the mail of which the transmission has been requested by the mail client is the same as the mail of which the transmission request has been received by the mail server, is judged from the transmitting source (a host name, and IP address, etc.) shown in FIG. 4 and FIG. 5. Note that a rate of detecting the abnormal mail transmission is increased by executing all the comparing processes which will be shown below, however, those may be executed through a proper selection or combination without being limited necessarily to this.

Moreover, the mail client may compare the latest request history data with the latest transmission history data and may thereby judge whether or not the mail of which the transmission has been requested by the mail client is the same as the mail of which the transmission request has been received by the mail server.

### COMPARATIVE EXAMPLE 1

The history check program 13 compares a transmitting date/time of the latest mail in the transmission history data accumulated by the mail server 5 responding to the request from the mail client 3 with a transmitting date/time of the latest mail in the request history data accumulated by the mail client 3. In case the request history data do not contain any mail transmission within a time zone approximate to transmitting date/time, this implies that the mail client 3 did not make the transmission request of the mail of which the transmission request has been received by the mail server 5. Namely, this implies a high possibility that the mail of which the transmission request has been received by the mail server 5 might be a mail transmitted by the virus.

### COMPARATIVE EXAMPLE 2

The history check program 13 compares a title of the mail in the updated transmission history data accumulated by the mail server 5 responding to the request from the mail client 3 with a title of the mail in the request history data accumulated by the mail client 3. In case the request history does not contain the title of the mail transmitted by the mail server, it is understood that the mail of which the transmission request has been received by the mail server 5 is not the mail of which the transmission has been requested by the mail client 3. Namely, this implies that the mail of which the transmission request has been received by the mail server 5 might be a mail transmitted by the virus.

### COMPARATIVE EXAMPLE 3

The history check program 13 compares a total number of the mails (the total number of mails transmitted responding to the transmission request from the mail client 3) in the transmission history data accumulated by the mail server 5 with a total number of mails (a total number of mails of which the transmission requests have been given to the server) in the request history data accumulated by the mail client 3. In case the total numbers of the mails on both sides are different, it is understood that the mail of which the transmission request has been received by the mail server 5 is not he mail of which the transmission has been requested by the mail client 3. Namely, a high possibility that the virus might transmit the mail by use of its own transmission engine, exists in the mails of which the transmission requests have been received by the mail server 5.

### COMPARATIVE EXAMPLE 4

The history check program 13 compares the data about the transmitting source in the transmission history data related to the latest transmission request mail from the mail client 3 with the data about the transmitting source in the request history data accumulated by the mail client 3. Note that the data about the transmitting source contain various categories of information for specifying the user such as a mail address of the transmitting source, a user name, etc. In case the mail addresses of both of the transmitting sources are different, it is understood that the mail of which the transmission request has been received by the mail server 5 is not the mail of which the transmission has been requested by the mail client 3. Namely, a possibility that the latest transmission request mail might be a mail transmitted by the virus by use of its own transmission engine, is considered high.

### COMPARATIVE EXAMPLE 5

The history check program 13 compares the test data of the latest mail in the transmission history data accumulated responding to the request from the mail client 3 with the text data of the latest mail in the request history data accumulated by the mail client 3. In case the text data accumulated on the mail server 5 do not exist in the text data accumulated on the mail client 3 or the contents of the text data are different, it is understood that the mail of which the transmission request has been received by the mail server 5 is not the mail of which the transmission has been requested by the mail client 3. Namely, a possibility that the mail of which the transmission request has been received by the mail server 5 might be a mail transmitted by the virus by use of its own transmission engine, is considered high. Note that in case the mail text is long, the text data of the mail may be managed as data different from the request history data and from the transmission history data.

### COMPARATIVE EXAMPLE 6

The history check program 13 compares a header of the latest mail of which the transmission request has been received from the mail client 3 in the transmission history data accumulated by the mail server 5 with a header of the latest mail in the request history data accumulated by the mail client 3. Through this, in the case of being different such as “Fwd (Forward)” in one header and “Re (Reply)” in the other header, or in a case where the header of the latest mail accumulated on the mail client 3 does not exist in the header of the latest mail accumulated on the mail server 5, it is understood that the mail of which the transmission request has been received by the mail server 5 is not the mail of which the transmission has been requested by the mail client 3. Namely, a possibility that the mail of which the transmission request has been received by the mail server 5 might be a mail transmitted by the virus by use of its own transmission engine, is considered high.

### COMPARATIVE EXAMPLE 7

The history check program 13 compares a transmission request receiving date/time of the oldest mail in the transmission history data accumulated by the mail server 5 with the transmitting date/time of the oldest mail in the request history data accumulated by the mail client 3. Note that a retaining period (e.g., one month) of the transmitting date/time is assumed to be the same on both sides. In the case of a compared result that the date/time is different on both sides, it is understood that the mail of which the transmission request has been received by the mail server 5 is not the mail of which the transmission has been requested by the mail client 3. Namely, a possibility that the mail of which the transmission request has been received by the mail server 5 might be a mail transmitted by the virus by use of its own transmission engine, is considered high. It is to be noted that this comparison would be suited to a case of periodically making the comparison rather than checking latest whether or not there is a possibility of being infected by the virus.

### COMPARATIVE EXAMPLE 8

The history check program 13 compares an attached file name in the latest in the transmission history data accumulated by the mail server 5 responding to the request from the mail client 3 with an attached file name in the latest mail in the request history data accumulated by the mail client 3. In case the attached mail name of the latest mail accumulated on the mail server 5 does not exist in the request history data of the mail client 3, it is understood that the mail of which the transmission request has been received by the mail server 5 is not the mail of which the transmission has been requested by the mail client 3. Namely, a possibility that the mail of which the transmission request has been received by the mail server 5 might be a mail transmitted by the virus, is considered high.

### COMPARATIVE EXAMPLE 9

The history check program 13 compares data about whether the attached file exists or not in the latest mail in the transmission history data accumulated by the mail server 5 responding to the request from the mail client 3 with data about whether the attached file exists or not in the latest mail in the request history data accumulated by the mail client 3. In case the mail of which the transmission request has been received by the mail server 5 has the attached file but the mail of which the transmission has been requested by the mail client 3 has no attached file, it is understood that the mail of which the transmission request has been received by the mail server 5 is not the mail of which the transmission has been requested by the mail client 3. Namely, a possibility that the mail of which the transmission request has been received by the mail server 5 might be a mail transmitted independently by the virus, is considered high.

### COMPARATIVE EXAMPLE 10

The history check program 13 compares data about a transmitting destination in the latest mail in the transmission history data accumulated by the mail server 5 responding to the request from the mail client 3 with data about a transmitting destination in the latest mail in the request history data accumulated by the mail client 3. Note that the data about the transmitting destination contain pieces of information for specifying the transmitting destination such as a mail address of the transmitting destination, a user name, etc. In case the data about the transmitting destinations are different on both sides, or in case the transmitting destination in the transmission history data accumulated on the mail server 5 does not exist in the transmitting destination in the request history data accumulated on the mail client 3, it is understood that the mail of which the transmission request has been received by the mail server 5 is not the mail of which the transmission has been requested by the mail client 3. Namely, a possibility that the mail of which the transmission request has been received by the mail server 5 might be a mail transmitted independently by the virus, is considered high.

### COMPARATIVE EXAMPLE 11

The history check program 13 compares the transmission history data accumulated by the mail server 5 responding to the request from the mail client 3 with the operation history data accumulated by the mail client 3. As shown in FIG. 7, the operation history data contain a booting time and a terminating time of the mail software, an address of the transmitting destination, an address of the transmitting source, a tile of the mail, an attached file existed or non-existed, a name of the attached file, a content of the mail text, etc.

For instance, an accepting date/time (a receiving date/time in FIG. 5) when the mail server 5 has accepted the transmission request of the mail in the transmission history data accumulated by the mail server 5, is compared with the a booting time (a booting date/time in FIG. 7) of the mail software in the operation history data accumulated by the mail client 3. In the case of a compared result that the accepting date/time when accepting the mail transmission request is not contained in the booting time, this mail is not the mail transmitted from the mail software. Namely, this implies a high possibility that the mail of which the transmission request has been received by the mail server 5 might be a mail transmitted by the virus by use of its own transmission engine.

Further, the history comparison check program 13 compares an accepting date/time (a receiving date/time in FIG. 5) when the mail server 5 has accepted the transmission request of the mail in the transmission history data accumulated by the mail server 5 with a booting termination time (a terminating time in FIG. 7) of the mail software in the operation history data accumulated by the mail client 3. In the case of a compared result that the accepting time is posterior to the booting termination time, the mail of which the transmission request has been given to the mail server 5 is not the mail transmitted from the mail software. Namely, this implies a high possibility that the mail of which the transmission request has been received by the mail server 5 might be a mail transmitted by the virus by use of its own transmission engine.

Moreover, the history comparison check program 13 may make:

(1) a comparison between the address of the transmitting destination of the mail in the transmission history data accumulated by the mail server 5 and the address of the transmitting destination in the operation history data accumulated by the mail client 3;

(2) a comparison between the address of the transmitting source in the transmission history data accumulated by the mail server 5 and the address of the transmitting source in the operation history data accumulated by the mail client 3;

(3) a comparison between the title of the mail in the transmission history data accumulated by the mail server 5 and the title of the mail in the operation history data accumulated by the mail client 3;

(4) a comparison between a content of the mail text in the transmission history data accumulated by the mail server 5 and a content of the mail in the operation history data accumulated by the mail client 3;

(5) a comparison between an attached file existed or non-existed in the transmission history data accumulated by the mail server 5 and an attached file existed or non-existed in the operation history data accumulated by the mail client 3; and

(6) a comparison between the title of the mail in the transmission history data accumulated by the mail server 5 and the title of the mail in the operation history data accumulated by the mail client 3. Each of these is the same as each of the items in the request history data accumulated by the aforementioned mail client 3, and the identity of both of the latest mails or the existence of non-existence of the coincident mail is checked by the comparison between the request history data and the operation history data. In case the identity between the latest mails is not seen, or in case there exists no coincident mail, this implies the high possibility of being transmitted by the virus.

Then, in case the history check program 13 judges in step 12 that there is no difference between both of these pieces of data, returning to step 08, and the same process is repeated. Namely, when the mail of which the transmission request has been received by the mail server 5 is identical with the mail transmitted by the mail client 3, the possibility of being infected by the virus is deemed low.

While on the other hand, in case the history check program 13 judges that there is a difference between these pieces of data, the possibility of being infected by the virus is considered high. Such being the case, the history check program 13 notifies the mail client 3 of a purport that there is the high possibility of being infected by the virus (S13).

The CPU of the mail client 3 receiving this notification displays the purport that there is the possibility of having been infected by the virus on the display of the mail client 3 (S14).

Through the procedure described above, it is feasible to detect the possibility of the existence of the virus that executes the mail transmission.

According to the abnormality detection method in the embodiment, it is feasible to detect the existence of the virus of such a type as to have the mail transmission function (the mail transmission engine) by itself and to transmit the mails at random.

In the embodiment, the existence of the virus is detected by comparing the transmission history data on the mail server 5 and the request history data on the mail client 3. The embodiment of the invention is not, however, limited to this architecture. For example, whether the virus exists or not may be detected by comparing the transmission condition data with the request history data. For instance, whether the virus exists or not is detected by checking a transmission of a destination to which nothing has been transmitted for a long period of time and transmissions of mails exceeding a predetermined number per predetermined time, etc. This, according to the abnormality detection method in the embodiment, makes it possible to cope with any types of viruses in the viruses of such a type as to have none of the mail transmission functions by themselves and to transmit the mail by exploiting the mail software of the mail client.

Further, the abnormality detection system/method in the embodiment detects the possibility of being infected by the virus in a way that compares the mail transmission history and the mail software operation history with the past histories. Therefore, even the mail client that does not yet introduce a piece of virus check software and also the mail client on which a corresponding piece of virus definition information is not yet updated, are capable of picking out the fact that the mail has been transmitted by the virus.

Moreover, the history check program is executed by the mail server, whereby the number of programs that must be executed by the mail client can be restrained. Namely, according to the abnormality detection system in the embodiment, the transmission history is checked without being influenced by the s of the terminal itself of the mail client, and the existence of the virus can be confirmed.

<Second Embodiment>

An abnormality detection system/method in an embodiment compares the request history data accumulated on the mail client 3 with the transmission history data accumulated on the mail server 5 on the side of the mail client 3.

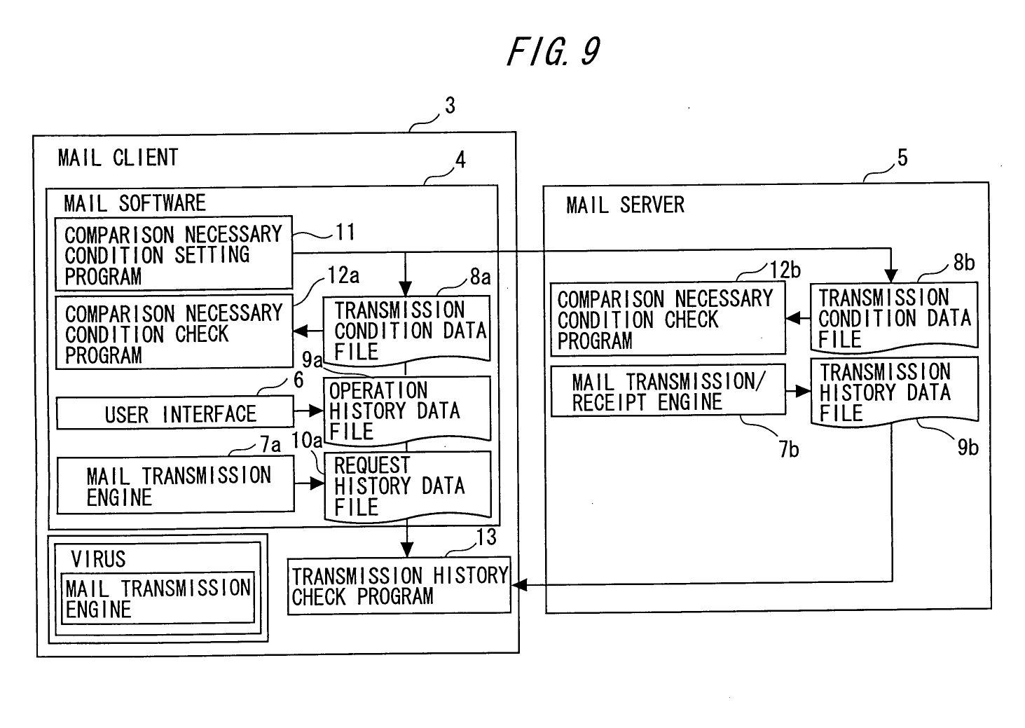

FIG. 9 shows a view of system architectures of the mail client 3 and of the mail server 5 in the embodiment. As shown in FIG. 9, the mail client 3 in the embodiment has the history check program 13. Note that the architectures of the mail server 5 and of the mail client 3, the contents of the data to be accumulated and the comparative items of the data in the embodiment, are the same as those in the first embodiment, and their repetitive explanations are omitted. In addition, the same components as those in the first embodiment are marked with the same symbols in the drawings.

An abnormality detection procedure in the embodiment will hereinafter be explained.

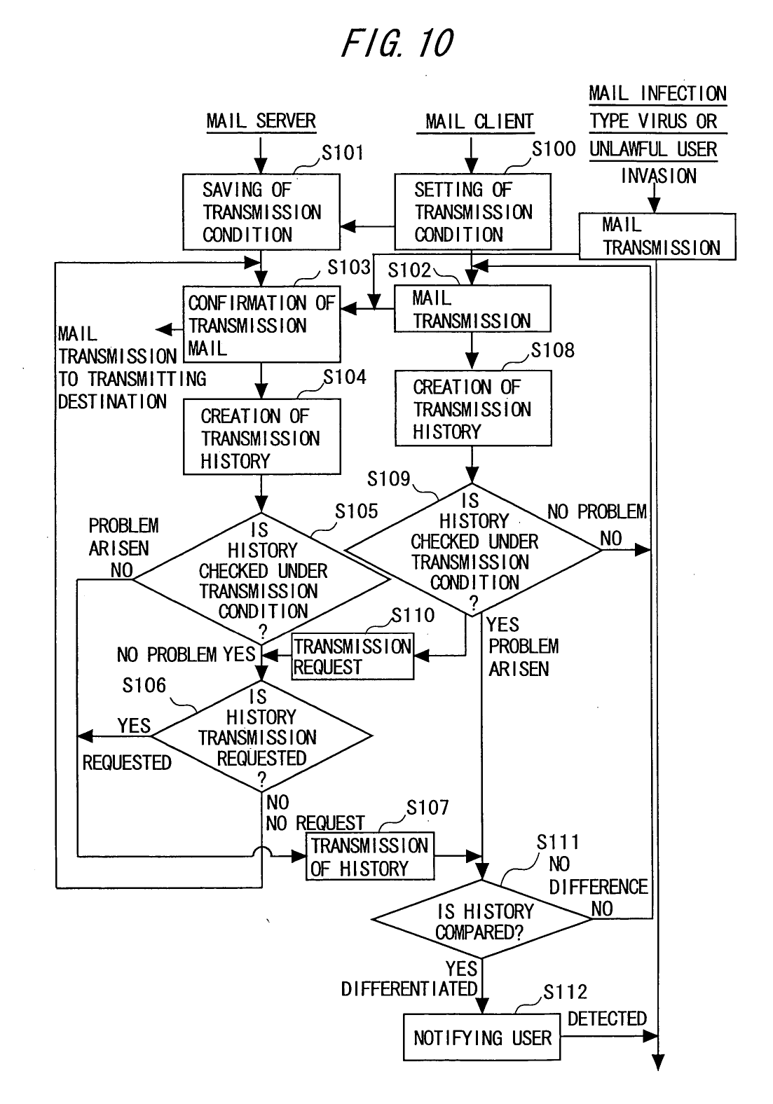

FIG. 10 shows a flowchart of the abnormality detection procedure in the embodiment.

To begin with, the CPU of the mail client 3 executes the comparison necessary condition setting program 11. Herein, the user sets the transmission condition data according to the comparison necessary condition setting program 11 (S100). In this setting, the setting contents shown in FIG. 5 are set as in the first embodiment.

Then, the transmission condition data set by the user are accumulated in the transmission condition data file 8a of the mail client 3.

The comparison necessary condition setting program 11, upon receiving a completion of setting the transmission condition data, transmits to the mail server 5 the transmission condition data inputted by the user. Upon receiving a completion of the transmission of the transmission condition data, the comparison necessary condition setting program 11 terminates.

The mail server 5 having received the setting contents (the transmission condition data) saves the setting contents in the transmission condition data file 8b (S101).

On the other hand, the mail client 3 transmits the mail to the mail server 5 after executing a process of determining the mail transmission. Namely,

the mail is transmitted from the mail client 3 (S102) the mail server 5 having received the mail from the mail client 3 accepts the mail transmitted from the mail client 3 (S103). The mail server 5, after confirming the acceptance of the mail, transmits the mail to the transmitting destination.

The CPU of the mail server 5, together with the mail transmission, together with the mail transmission, accumulates the transmission history data of the mail in a predetermined file (S104). Note that the transmission history data herein connote the transmission history data shown in FIG. 5 as in the first embodiment.

The CPU of the mail server 5, corresponding to the accumulation of the transmission history data, executes the comparison necessary condition check program 12b (S105). The comparison necessary condition check program 12b compares the transmission history data accumulated by the mail server 5 itself with the transmission condition data transmitted from the mail client 3 in step 101.

The comparison necessary condition check program 12b executes, based on the transmission condition data and the transmission history data, a comparing process as to items of whether or not a predetermined number of days (for example, two weeks) have elapsed since the comparing date/time of the last time, whether or not the comparing process is executed after receiving the updated virus information, whether or not the mail transmission count exceeds a set value (for instance, 50 mails), and whether or not the have-the-same-content mail transmission count exceeds a set value (e.g., 10 mails).

In case the comparison necessary condition check program 12b judges in step 105 that the transmission history data do not meet the transmission condition data, checks whether a request for transmitting the request history data is given from the mail client 3 or not (S106).

Here, in case the comparison necessary condition check program 12b judges that the request for transmitting the request history data is not given from the mail client 3, returning to step 103, and the same process is repeated.

While on the other hand, in case the comparison necessary condition check program 12b judges that the request for transmitting the request history data is given from the mail client 3, the transmission history data are transmitted to the mail client 3 (S107).

Further, in case the comparison necessary condition check program 12b judges in step 105 that the transmission history data meet the transmission condition data, it follows that there is a necessity of comparing the request history data accumulated by the mail client 3 with the transmission history data accumulated by the mail server 5.

Then, the comparison necessary condition check program 12b sends the accumulated transmission history data to the mail client 3 (S107).

Moreover, the CPU of the mail client 3 creates and accumulates, in step 102, when requesting the mail server 5 to transmit the mail, the request history data of this mail in a predetermined file (S108). The request history data created herein contain the same request history data shown in FIG. 4 and the same operation history data shown in FIG. 7 as those in the first embodiment.

Upon a completion of accumulating the request history data, the CPU of the mail client 3 executes the comparison necessary condition check program 12a. The comparison necessary condition check program 12a executes a process of comparing the transmission condition data set by the comparison necessary condition setting program 11 with the request history data accumulated (S109). Note that the contents of the comparison are the same as the contents of the comparison by the comparison necessary condition check program 12b on the mail server 5, and therefore the explanation is omitted.

In case the comparison necessary condition check program 12a judges in step 109 that the transmission history data do not meet the transmission condition data, moving back to step 102, and the same process is repeated.

While on the other hand, in case the comparison necessary condition check program 12a judges in step 109 that the transmission history data meet the transmission condition data, the comparison necessary condition check program 12a executes a request process for transmitting the transmission history data to the mail server 5 (S110)

the CPU of the mail client 3, responding to a receipt of the transmission history data transmitted from the mail server 5, executes the history check program 13 (S111).

The history check program 13 compares the request history data accumulated on the mail client 3 which are shown in FIG. 4 with the transmission history data accumulated on the mail server 5 which are shown in FIG. 5. Note that the contents of the comparison are the same as the “comparative examples” explained in the first embodiment, and hence the explanation is omitted.

In case the history check program 13 judges in step 111 that there is no difference between both pieces of data, getting back to step 102, and the same process is repeated. Namely, in case the mail transmitted from the mail client 3 is the same as the mail of which the transmission request has been given to the mail server 5, the possibility that the mail client 3 might be infected by the virus is deemed low.

While on the other hand, in case the history check program 13 judges that there is a difference between both pieces of data, the possibility that the mail client 3 might be infected by the virus is considered high. Then, the history check program 13 notifies the user of a purport that the possibility of being infected by the virus is high by displaying it on the display of the mail client 3 (S112).

Through the procedure described above, it is feasible to inform of the possibility that there exists the virus executing the mail transmission.

As explained above, the abnormality detection system/method in the embodiment has the architecture for executing the history check program on the side of the mail client. Therefore, even in the event of the mail server being infected by the virus, the detection of the abnormality can be supported on the side of the mail client. This enables the virus infection from being restrained to the minimum.

According to the architecture shown in the first embodiment or the second embodiment, it is possible to detect the defect in operation of the computer which is derived from the general mismatched operations between the server and the client. This type of operation defect is not limited to what is caused by the computer virus.

### MODIFIED EXAMPLE 1

An architecture in which the history comparing program explained in the first embodiment and in the second embodiment is executed by both of the mail client and the mail server, can be given by way of a modified example 1 of the embodiment. This modified example 1 can be actualized by installing the history comparing program into the HD of the mail client and into the HD of the mail server.

### MODIFIED EXAMPLE 2

Moreover, as a modified example 2 of the embodiment, as in the modified example of the embodiment, the existence of the virus may be detected by comparing the request history data or the operation history data of the mail client 3 with the transmission conditions. For example, “the transmittable mail count permitted by the client within the fixed time” described in L4 in the transmission condition data example shown in FIG. 6, is set to 50 mails. Note that the fixed time herein connotes a time for which the mail software is kept booting. This transmission condition is compared with “the transmitting process count during the booting time” in the operation history data shown in FIG. 7. Through this comparison, in case the transmitting process count during the booting time exceeds 50 mails, a possibility that the virus is transmitting the mail by exploiting the mail software or some abnormality occurs in the mail software, can be deemed high.

<Other Embodiments>

Further, a mode in which a device (which will hereinafter be referred to as a check device) other than the mail client and the mail server executes the check program of the invention, can be exemplified by way of other embodiment of the invention. In the case of this mode, the mail client and mail server transmit the history data (the request history data, the operation history data, the transmission history data) accumulated individually to the check device. The check device executes the check program, and compares the history data on the mail client and the history data on the mail server.

From the above-mentioned, according to the invention, it is possible to provide the abnormality detection method, the abnormality detection program, the server and the computer which detect the operational abnormality of the computer that is derived from the virus and other causes.

Further, according to the invention, it is feasible to provide the abnormality detection method, the abnormality detection program, the server and the computer which detect a clue to an unknown virus without requiring a pattern file.

What is claimed is:

1. An abnormality detection method on a server, by which the server for providing an electronic mail transmission service via a network to a computer making a request for transmitting an electronic mail detects an operational abnormality of the computer, the method comprising:
a step of accepting the electronic mail transmission request from the computer;
a step of transmitting the electronic mail of which the transmission request has been accepted;
a step of accumulating transmission history information about the transmitted electronic mail;
a step of referring to request history information about a transmission request history of the electronic mail that is accumulated on the computer;
a step of comparing the transmission history information with the request history information; and
a step of detecting the operational abnormality of the computer on the basis of a result of the comparison.

2. An abnormality detection method on a server according to claim 1, further comprising:
a step of referring to a transmission confirming condition on the computer when transmitting the electronic mail;
a step of confirming the transmission history information containing the latest transmitted electronic mail in accordance with the transmission confirming condition; and
a step of referring to, in case the result of the confirmation in the confirming step meets a predetermined standard, the request history information and comparing the request history information with the transmission history information.

3. An abnormality detection method on a server, by which the server for providing an electronic mail transmission service via a network to a computer making a request for transmitting an electronic mail detects an operational abnormality of the computer, the method comprising:
a step of accepting the electronic mail transmission request from the computer;
a step of transmitting the electronic mail of which the transmission request has been accepted;
a step of accumulating transmission history information about the transmitted electronic mail;
a step of referring to a transmission confirming condition on the computer when transmitting the electronic mail;
a step of confirming the transmission history information containing the latest transmitted electronic mail in accordance with the transmission confirming condition; and
a step of detecting the operational abnormality of the computer on the basis of a result of the confirmation.

4. An abnormality detection method on a server according to claim 1 or 3, further comprising a step of informing the computer that the operational abnormality of the computer has been detected.

5. An abnormality detection method on a server according to any one of claims 1-3, further comprising:
a step of referring to the operation history information of mail software for making a request for transmitting the mail on the computer;
a step of comparing the operation history information with the transmission history information; and
a step of detecting the operational abnormality of the computer when a content of the transmission history information is in a predetermined relationship with a content of the operation history information.

6. An abnormality detection method on a server according to any one of claims 1-3, wherein the server is a relay device for relaying the electronic mail to a transmitting destination.

7. An abnormality detection method on a server, by which the server for providing an electronic mail transmission service via a network to a computer making a request for transmitting an electronic mail detects an operational abnormality of the computer, the method comprising:
a step of accepting the electronic mail transmission request from the computer;
a step of transmitting the electronic mail of which the transmission request has been accepted;
a step of accumulating transmission history information about the transmitted electronic mail;
a step of making the computer refer to the transmission history information; and
a step of making the computer confirm the operational abnormality of the computer on the basis of the transmission history information.

8. An abnormality detection method on a server according to claim 7, further comprising:
a step of referring to a transmission confirming condition on the computer when transmitting the electronic mail;
a step of confirming the transmission history information containing the latest transmitted electronic mail in accordance with the transmission confirming condition; and
a step of making the computer refer to, in case the result of the confirmation in the confirming step meets a predetermined standard, the transmission history information.

9. An abnormality detection method of detecting an operational abnormality of a computer, executed by an electronic mail system comprising the computer for making a request for transmitting an electronic mail and a server for transmitting the electronic mail in response to the request from the computer, the method comprising:
a step of referring to request history information related to a transmission request history of the electronic mail by the computer;
a step of referring to transmission history information of the electronic mail by the server;
a step of comparing the request history information with the transmission history information; and
a step of detecting the operational abnormality of the computer on the basis of a result of the comparison.

10. An abnormality detection method on a computer, by which the computer requesting a server for providing an electronic mail transmission service to transmit an electronic mail via a network detects an operational abnormality of the computer, the method comprising:
a step of requesting the server to transmit the electronic mail;
a step of accumulating request history information about the electronic mail of which the transmission has been requested;
a step of referring to transmission history information related to a transmission history of the electronic mail accumulated on the server;
a step of comparing the request history information with the transmission history information; and
a step of detecting the operational abnormality on the basis of a result of the comparison.

11. An abnormality detection method on a computer according to claim 10, further comprising:
a step of referring to a transmission confirming condition on the computer when transmitting the electronic mail;
a step of confirming the request history information containing the latest transmitted electronic mail in accordance with the transmission confirming condition; and
a step of referring to, in case a result of the confirmation in the confirming step meets a predetermined standard, the transmission history information and comparing the transmission history information with the request history information.

12. An abnormality detection method on a computer according to claim 10 or 11, further comprising:
a step of referring to the operation history information of mail software for making a request for transmitting the mail on the computer;
a step of comparing the operation history information with the transmission history information; and
a step of detecting the operational abnormality of the computer when a content of the transmission history information is in a predetermined relationship with a content of the operation history information.

13. An abnormality detection method on a computer, by which the computer requesting a server for providing an electronic mail transmission service to transmit an electronic mail via a network detects an operational abnormality of the computer, the method comprising:
a step of transmitting the electronic mail;
a step of accumulating history information about the transmitted electronic mail;
a step of referring to a transmission confirming condition on the computer when transmitting the electronic mail;
a step of confirming the history information containing the latest transmitted electronic mail in accordance with the transmission confirming condition; and
a step of detecting an operational abnormality on the basis of a result of the confirmation.

14. An abnormality detection method on a computer according to any one of claims 10, 11 and 13, further comprising a step of informing the computer that the operational abnormality of the computer has been detected.

15. An abnormality detection method on a computer, by which the computer requesting a server for providing an electronic mail transmission service to transmit an electronic mail via a network detects an operational abnormality of the computer, the method comprising:
a step of requesting the server to transmit the electronic mail;
a step of accumulating request history information about the electronic mail of which the transmission has been requested;
a step of making the server refer to the request history information; and
a step of making the server confirm the operational abnormality of the computer on the basis of the request history information.

16. An abnormality detection method on a computer according to any one of claims 13, 15, further comprising:
a step of referring to a transmission confirming condition on the computer when transmitting the electronic mail;
a step of confirming the transmission history information containing the latest transmitted electronic mail in accordance with the transmission confirming condition; and
a step of making the computer, in case a result of the confirmation in the confirming step meets a predetermined standard, refer to the request history information.

17. A storage medium that stored an detection program by which a server for providing an electronic mail transmission service via a network to a computer making a request for transmitting an electronic mail detects an operational abnormality of the computer, the program making the server execute:
a step of referring to transmission history information related to the electronic mail transmitted based on the transmission request of the electronic mail from the computer;
a step of referring to request history information related to a transmission request history of the electronic mail by the computer;
a step of comparing the transmission history information with the request history information; and
a step of detecting the operational abnormality of the computer on the basis of a result of the comparison.

18. A storage medium that stored an abnormality detection program according to claim 17, further comprising:
a step of referring to a transmission confirming condition on the computer when transmitting the electronic mail;
a step of confirming the transmission history information containing the latest transmitted electronic mail in accordance with the transmission confirming condition; and
a step of referring to, in case a result of the confirmation in the confirming step meets a predetermined standard, the request history information and comparing the request history information with the transmission history information.

19. A storage medium that stored an abnormality detection program by which a server for providing an electronic mail transmission service via a network to a computer making a request for transmitting an electronic mail detects an operational abnormality of the computer, the program making the server execute:
a step of referring to transmission history information related to the electronic mail transmitted based on the transmission request of the electronic mail from the computer;
a step of referring to a transmission confirming condition on the computer when transmitting the electronic mail;
a step of confirming the transmitted transmission history information containing the latest electronic mail in accordance with the transmission confirming condition; and
a step of detecting the operational abnormality of the computer on the basis of a result of the confirmation.

20. A storage medium that stored an abnormality detection program according to any one of claims 17-19, further comprising:
a step of referring to the operation history information of mail software for making a request for transmitting the mail on the computer;
a step of comparing the operation history information with the transmission history information; and
a step of detecting the operational abnormality of the computer when a content of the transmission history information is in a predetermined relationship with a content of the operation history information.

21. A storage medium that stored an abnormality detection program according to any one of claims 17-19, wherein the server is a relay device for relaying the electronic mail to a transmitting destination.

22. A storage medium that stored an abnormality detection program according to any one of claims 17-19, further comprising a step of informing the computer that the operational abnormality of the computer has been detected.

23. A storage medium that stored an abnormality detection program by which a computer requesting a server for providing an electronic mail transmission service to transmit an electronic mail via a network detects an operational abnormality of the computer, the method making the server execute:
a step of making the computer refer to the transmission history information related to the electronic mail transmitted and accumulated based on the transmission request of the electronic mail from the computer; and
a step of making the computer confirm the operational abnormality of the computer on the basis of the transmission history information.

24. A storage medium that stored an abnormality detection program executed by an electronic mail system comprising a computer for making a request for transmitting an electronic mail and a server for transmitting the electronic mail in response to the request from the computer, the program making it execute:
a step of referring to request history information related to a transmission request history of the electronic mail by the computer;
a step of referring to transmission history information of the electronic mail by the server;
a step of comparing the request history information with the transmission history information; and
a step of detecting an operational abnormality of the computer on the basis of a result of the comparison.

25. A storage medium that stored an abnormality detection program according to claim 23 or 24, further comprising:
a step of referring to a transmission confirming condition when transmitting the electronic mail on the computer;
a step of confirming the transmission history information containing the latest transmitted electronic mail in accordance with the transmission confirming condition; and
a step of making the computer refer to, in case a result of the confirmation in the confirming step meets a predetermined standard, the transmission history information.

26. A storage medium that stored an abnormality detection program by which a computer requesting a server for providing an electronic mail transmission service to transmit an electronic mail via a network detects an operational abnormality of the computer, the program making the computer execute:
a step of referring to request history information related to the electronic mail of which the transmission request has been given to the server;
a step of referring to transmission history information about a transmission history of the electronic mail accumulated on the server;
a step of comparing the request history information with the transmission history information; and
a step of detecting the operational abnormality of the computer on the basis of a result of the comparison.

27. A storage medium that stored an abnormality detection program according to claim 26, further comprising:
a step of referring to a transmission confirming condition on the computer when transmitting the electronic mail;
a step of confirming the request history information containing the latest transmitted electronic mail in accordance with the transmission confirming condition; and
a step of referring to, in case a result of the confirmation in the confirming step meets a predetermined standard, the transmission history information and comparing the transmission history information with the request history information.

28. A storage medium that stored an abnormality detection program according to claim 26 or 27, further comprising:
a step of referring to the operation history information of mail software for making a request for transmitting the mail on the computer;
a step of comparing the operation history information with the transmission history information; and
a step of detecting the operational abnormality of the computer when a content of the transmission history information is in a predetermined relationship with a content of the operation history information.

29. A storage medium that stored an abnormality detection program by which a computer requesting a server for providing an electronic mail transmission service to transmit an electronic mail via a network detects an operational abnormality of the computer, the program making the computer execute:
a step of accumulating history information related to he electronic mail transmitted;
a step of referring to a transmission confirming condition on the computer when transmitting the electronic mail;
a step of confirming the history information containing the latest transmitted electronic mail in accordance with the transmission confirming condition; and
a step of detecting the operational abnormality of the computer on the basis of a result of the confirmation.

30. A storage medium that stored an abnormality detection program according to any one of claims 24, 26, 29, further comprising a step of informing the computer that the operational abnormality of the computer has been detected.

31. A storage medium that stored an abnormality detection program by which a computer requesting a server for providing an electronic mail transmission service to transmit an electronic mail via a network detects an operational abnormality of the computer, the method making the computer execute:
a step of accumulating request history information related to the electronic mail of which the transmission request has been given to the server;
a step of making the server refer to the request history information; and
a step of confirming the operational abnormality of the computer on the basis of the request history information.

32. A storage medium that stored an abnormality detection program according to claim 29 or 30, further comprising:
a step of referring to a transmission confirming condition on the computer when transmitting the electronic mail;
a step of confirming the transmission history information containing the latest transmitted electronic mail in accordance with the transmission confirming condition; and
a step of making the computer refer to, in case a result of the confirmation in the confirming step meets a predetermined standard, the request history information.

33. A server for providing an electronic mail transmission service to a computer making a request for transmitting an electronic mail, comprising:
an accepting unit accepting an electronic mail transmission request from the computer;
a transmitting unit transmitting the electronic mail of which the transmission request has been accepted;
an accumulating unit accumulating transmission history information about the transmitted electronic mail;
a history referring unit referring, from on the computer, to request history information about a transmission request history of the electronic mail that is accumulated on the computer;
a comparing unit comparing the transmission history information with the request history information; and
a detecting unit detecting an operational abnormality of the computer on the basis of a result of the comparison.

34. A server according to claim 33, further comprising:
a referring unit referring to a transmission confirming condition on the computer when transmitting the electronic mail; and
a confirming unit confirming the transmission history information containing the latest transmitted electronic mail in accordance with the transmission confirming condition,
wherein in case a result of the confirmation by the confirming unit meets a predetermined standard, the history referring unit refers to the request history information, and the comparing unit compares the request history information with the transmission history information.

35. A server for providing an electronic mail transmission service to a computer making a request for transmitting an electronic mail, comprising:
an accepting unit accepting the electronic mail transmission request from the computer;
a transmitting unit transmitting the electronic mail of which the transmission request has been accepted;
an accumulating unit accumulating transmission history information about the transmitted electronic mail;
a condition referring unit referring to a transmission confirming condition on the computer when transmitting the electronic mail;
a confirming unit confirming the transmission history information containing the latest transmitted electronic mail in accordance with the transmission confirming condition; and
a detecting unit detecting an operational abnormality of the computer on the basis of a result of the confirmation.

36. A server according to any one of claims 33-35, further comprising an informing unit informing the computer that the operational abnormality of the computer has been detected.

37. A server according to any one of claims 33 to 36, further comprising:
a unit referring to the operation history information of mail software for making a request for transmitting the mail on the computer,
wherein the comparing unit includes a unit comparing the operation history information of the mail software with the transmission history information, and
the detecting unit detects the operational abnormality of the computer when a content of the transmission history information is in a predetermined relationship with a content of the operation history information.

38. A server according to any one of claims 33-35, wherein the server is a relay device for relaying the electronic mail to a transmitting destination.

39. A server for providing an electronic mail transmission service to a computer making a request for transmitting an electronic mail, comprising:
an accepting unit accepting the electronic mail transmission request from the computer;
a transmitting unit transmitting the electronic mail of which the transmission request has been accepted;
an accumulating unit accumulating transmission history information about the transmitted electronic mail; and
a reference instructing unit making the computer refer to the transmission history information,
wherein the computer is made to confirm the operational abnormality of the computer on the basis of the transmission history information.

40. A server according to claim 39, further comprising:
a condition referring unit referring to a transmission confirming condition on the computer when transmitting the electronic mail; and
a confirming unit confirming the transmission history information containing the latest transmitted electronic mail in accordance with the transmission confirming condition,
wherein the reference instructing unit makes the computer refer to, in case the result of the confirmation by the confirming unit meets a predetermined standard, the transmission history information.

41. A computer requesting a server for providing an electronic mail transmission service to transmit an electronic mail, comprising:
a requesting unit requesting the server to transmit the electronic mail;
an accumulating unit accumulating request history information about the electronic mail of which the transmission has been requested;
a server history referring unit referring, from on the server, to transmission history information about a transmission history of the electronic mail that is accumulated on the server;
a comparing unit comparing the request history information with the transmission history information; and
a detecting unit detecting an operational abnormality on the basis of a result of the comparison.

42. A computer comprising:
a first referring unit referring to a request history information about a transmission request history of the electronic mail by the computer requesting the server to transmit the electronic mail;
a second referring unit referring the transmission history information of the electronic mail by the server transmitting the electronic mail in response to the request for the electronic mail;
a comparing unit comparing the request history information with the transmission history information; and
a detecting unit detecting an operational abnormality of the computer on the basis of a result of the comparison.

43. A computer according to claim 41, further comprising
a condition referring unit referring a transmission confirming condition on the computer when transmitting the electronic mail; and
a confirming unit confirming the request history information containing the latest transmitted electronic mail in accordance with the transmission confirming condition,
wherein in case a result of the confirmation by the confirming unit meets a predetermined standard, the history referring unit in the server refers to the transmission history information, and the comparing unit compares the transmission history information with the request history information.

44. A computer according to any one of claims 41-43, further comprising operation history referring unit referring to the operation history information of mail software for transmitting the mail on the computer,
wherein the comparing unit includes comparing unit comparing the request history information with the operation history information, and
the detecting unit, when a content of the history information is in a predetermined relationship with a content of the operation history information, detects the operational abnormality.

45. A computer requesting a server for providing an electronic mail transmission service to transmit an electronic mail, comprising:
a transmitting unit transmitting the electronic mail;
an accumulating unit accumulating history information about the transmitted electronic mail;
a condition unit referring to a transmission confirming condition on the computer when transmitting the electronic mail;
a confirming unit confirming the history information containing the latest transmitted electronic mail in accordance with the transmission confirming condition; and
a detecting unit detecting an operational abnormality on the basis of a result of the confirmation.

46. A computer according to any one of claims 41-45, further comprising informing unit informing the computer that the operational abnormality of the computer has been detected.

47. A computer requesting a server for providing an electronic mail transmission service to transmit an electronic mail, comprising:
a unit requesting the server to transmit the electronic mail;
an accumulating unit accumulating request history information about the electronic mail of which the transmission has been requested; and
a reference instructing unit making the server refer to the request history information,
wherein the server is made to confirm the operational abnormality of the computer on the basis of the request history information.

48. A computer according to claim 47, further comprising:
a condition referring unit referring to a transmission confirming condition on the computer when transmitting the electronic mail; and
a request history confirming unit confirming the request history information containing the latest transmitted electronic mail in accordance with the transmission confirming condition,
wherein the reference instructing unit makes the server refer to, in case a result of the confirmation by the request history confirming unit meets a predetermined standard, the request history information.
